(19) United States
(12) Patent Application Publication
(10) Pub. No.: US 2017/0144112 A1
(43) Pub. Date: May 25, 2017

(54) NANOPOROUS POLYMER MEMBRANES AND METHODS OF PRODUCTION

(71) Applicant: MONASH UNIVERSITY, Clayton, Victoria (AU)

(72) Inventors: Huanting WANG, Glen Waverley (AU); Kun WANG, Endeavour Hills (AU)

(73) Assignee: MONASH UNIVERSITY, Clayton, Victoria (AU)

(21) Appl. No.: 15/129,890

(22) PCT Filed: Apr. 22, 2015
(86) PCT No.: PCT/AU2015/000233

§ 371 Date: Sep. 28, 2016

(30) Foreign Application Priority Data
Apr. 29, 2014 (AU) 2014901536

(51) Int. Cl. B01D 71/68; C08J 5/22; B01D 69/02; B01J 41/13; B01D 61/14; B01D 69/14

(52) U.S. Cl. CPC B01D 71/68; B01D 61/145; B01D 69/141; B01D 69/02; B01J 41/13; C08J 5/2256; B01D 2325/36; B01D 2325/20; B01D 2323/02; C08J 2381/06; C08J 2481/06

(57) ABSTRACT

An ultrafiltration membrane comprising: (i) a first polymer, and (ii) a second, charged polymer wherein the first polymer and second polymer have different hydrophobicities.

### FIELD OF INVENTION

The present invention relates to the field of membrane technology.

In one form, the invention relates to nanoporous polymeric membranes, particularly polyethersulphone membranes.

In another form, the invention provides nanoporous membranes suitable for liquid purification, particularly water purification.

In one particular aspect the present invention is suitable for use in filtration.

It will be convenient to hereinafter describe the invention in relation to water filtration however, it should be appreciated that the present invention is not limited to that use only and many other applications will be apparent to the person skilled in the art.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

By definition, ultrafiltration membranes can reject particles and macromolecules of 2 to 100 nm in size. Ultrafiltration membranes are synthesised by various methods including phase inversion of polymer solutions, or phase separation of polymer blends.

Optimally, ultrafiltration membranes have high selectivity, high flux and excellent antifouling properties.

Nanoporous membranes are widely used in ultrafiltration processes for a diverse range of applications such as water treatment and food processing. Many polymers such as cellulose acetate, polyacrylonitrile copolymers, polysulphone, polyethersulphone and poly(vinylidene fluoride) are commonly used to produce membranes for these purposes. The nanoporous membranes typically possess an asymmetric porous structure which is typically achieved via a phase inversion method. High-flux membranes are highly desirable for high separation efficiency processes in order to reduce the process costs. Increasing membrane hydrophilicity by introducing hydrophilic groups on the active skin layer or throughout the membranes is an effective way to improve the membrane flux and other properties such as fouling resistance.

However, the water flux of existing polymer membranes is far below that of functional nanopores with fast water transport properties, such as biological water-channel proteins, protein-based membranes, and synthetic carbon nanotubes. For instance, as reported by Holt et al. (Science 2006 312(5776) p.1034) water transport rates through synthetic sub-2-nanometer carbon nanotubes are three orders of magnitude higher than theoretical values predicted by continuum flow models and this is attributed to slip flow at the inter-surface (Falk K et al. Nano Letter 2010 10(10) p.4067; Joseph S et al. Nano Letter 2008 8(2) p.452).

But these nanoporous systems with fast water transport properties are often chemically and mechanically unstable. Alternatively, it is often difficult to scale up their manufacture from bench-scale synthesis to commercial manufacture.

Accordingly, efforts have been made to overcome some of the deficiencies associated with existing polymer membranes to obtain improved characteristics, particularly improved hydrophilic properties. These typically fall into one of three categories; (i) direct materials modification before membrane preparation (pre-modification), (i) blending of a polymer matrix with a modifying agent in a casting solution during membrane preparation (additive), and (iii) surface modification after ultrafiltration membrane preparation (post-modification).

There have also been many attempts to increase the flux of ultrafiltration membranes however their application is often limited by intrinsic hydrophobic properties of polymer membranes.

There have been many attempts to prepare charged polymers with high thermal stability and high ionic conductivity such as quaternary phosphonium polymers. These attempts have focusses on synthesis of ion exchange membranes for fuel cells. However, these ion exchange membranes are not designed for applications such as water purification and are instead designed for use in either highly acidic or highly alkaline environment of fuel cells.

However, membranes for desalination processes have been constructed, by casting quaternary phosphonium polymer onto a piece of commercially available polyethersulphone substrate.

Several publications address the issue of obtaining a desired pore size in microporous phase inventions membranes. U.S. Pat. No. 6,267,916 (Meyering et al 1999) teaches a process of making microporous phase inversion membranes having any one of a plurality of different pore sizes derived from a master dope batch. U.S. Pat. 7,560,024 (Kools et al 2009), US 2003/0038391 (Meyering et al 2001) and U.S. Pat. No 6,056,529 (Meyering et al 2000) describe methods and systems for controlling pore size of microporous phase inversion membranes using hydrophilicity.

U.S. Pat. No. 6,071,406 (Tsou 2000) teaches a method of enhancing hydrophilicity of a hydrophobic membrane by adding a specified agent to the system used in casting.

### SUMMARY OF INVENTION

An object of the present invention is to provide an ultrafiltration membrane having enhanced fluid flux, particularly water flux.

Another object of the present invention is to provide an ultrafiltration membrane with improved fluid permeability, particularly water permeability.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided an ultrafiltration membrane comprising:

(i) a first polymer, and

(ii) a second, charged polymer

wherein the first polymer and second polymer have different hydrophobicities.

Typically the first polymer (or matrix polymer) is selected from any convenient polymer membrane material. In a particularly preferred embodiment the first polymer is chosen from the group comprising polysulphone, polyethersulphone (PES), polyacrylonitrile, cellulose acetate or poly(vinylidene fluoride)

Typically the second polymer (or additive polymer) is selected from any convenient positively charged or negatively charged polymer which has a greater hydrophobicity (corresponding to lesser hydrophilicity) than the first polymer. Preferably the second polymer is a quaternary phosphonium polymer. In a particularly preferred embodiment the second polymer is chosen from the group comprising diphenyl(3-methyl-4-methoxyphenyl) tertiary sulphonium functionalized polysulphone, tris(2,4,6-trimethoxyphenyl) quaternary phosphonium-substituted bromomethylated poly(phenylene oxide), sulphonated poly(2,6-dimethyl-1,4-phenylene oxide) and tris(2,4,6-trimethoxyphenyl)polysulphone-methylene quaternary phosphonium chloride.

In a second aspect of embodiments described herein there is provided an ultrafiltration membrane comprising:

(i) a first polymer, and

(ii) a second, charged polymer having a different hydrophobicity from the first polymer,

and wherein the ultrafiltration membrane exhibits a charge density gradient.

In a third aspect of embodiments described herein there is provided an ultrafiltration membrane comprising:

(i) a first polymer, and

(ii) a second, charged polymer having a different hydrophobicity from the first polymer,

and wherein the ultrafiltration membrane exhibits a hydrophilicity gradient.

In a fourth aspect of embodiments described herein there is provided an ultrafiltration membrane comprising:

(i) a first polymer, and

(ii) a second, charged polymer having a different hydrophobicity from the first polymer,

and wherein the ultrafiltration membrane exhibits a hydrophilicity gradient and a charge gradient.

Typically the first polymer acts as a matrix and the second polymer is added to obtain a desired composition gradient. The ultrafiltration membrane of the present invention typically has a high degree of polarisation, such that it has distinct hydrophilic and hydrophobic ends. More particularly, the hydrophilicity/hydrophobicity exhibits a gradient between two ends, such as between the skin layer and the bottom layer of the polymer.

Preferably the ultrafiltration membrane has graded charge density. By contrast, ultrafiltration membranes of the prior art typically have a constant charge density, or a have charged active layer, not a gradient.

The ultrafiltration membrane of the present invention typically has water permeability 5 to 10 times greater than commercially available ultrafiltration membranes of the prior art (such as those described in Hoek, et al Desalination 2011, 283, p. 89-99 and Peeva et al, Journal of Membrane Science 2012, 390-391, 99-112). Typically the ultrafiltration membrane of the present invention has water permeability between 0.46 and 20.00 L/m² h kPa, more preferably between 10 and 16 L/m² h kPa.

Furthermore, the water flux is up to ten times greater than prior art membranes. Typically the ultrafiltration membrane of the present invention has water flux of between 25 and 2000 Lm⁻² h⁻¹ at a testing pressure of 100 kPa, preferably between 1,000 and 1,500 Lm⁻² h⁻¹ at a testing pressure of 100 kPa.

Without wishing to be bound by theory it is believed that high water flux through the membrane is due to the wetability and charge density gradients along the porous channels in the membrane, which gradients are produced by introducing a hydrophobic and charged polymer in the membrane formation process.

In a fifth aspect of embodiments described herein there is provided a method of making an ultrafiltration membrane comprising the step of combining a first polymer with a second charged polymer having a different hydrophobicity from the first polymer. Preferably the combination creates a hydrophilicity gradient and a charge gradient in the membrane.

The ultrafiltration membrane may be manufactured by a number of different methods. In a preferred embodiment there is provided a method of manufacturing the ultrafiltration membrane of the present invention including the step of phase inversion.

For example, owing to the difference in hydrophilicity/hydrophobicity, ultrafiltration membranes according to the present invention and having a gradient distribution of the second polymer can be produced by a phase inversion mechanism, resulting in a gradient distribution of charge and pore surface properties.

An organic solvent or combination of solvents is typically used in the manufacture of the ultrafiltration membrane and the specific organic solvent, or combination of solvents may depend on the types of polymers used in the membrane fabrication and the desired microstructure of the final membrane. For example, the organic solvent used for dissolving the first polymer (matrix) and the second polymer (additive) could be chosen from N-methyl-2-pyrrolidone, dimethylformamide, or mixtures thereof.

In a particularly preferred embodiment the method of manufacture includes the steps of phase inversion and the addition of quaternary-phosphonium polymer. For example, the polyethersulphone substrate and quaternary-phosphonium polymer may be dissolved in a solvent and then cast on a clean glass substrate.

Typically, when phase inversion is used the total polymer concentration in solution is between about 12 and 20 wt %. Typically, the amount of second polymer is up to 60 wt % of the total amount of polymer in solution.

Without wishing to be bound by theory it is believed that the simple phase inversion process comprising addition of second polymer into the casting solution enhances performance of the membrane by inducing hydrophilicity and charge distribution gradients.

Many synthetic polymeric membranes of the prior art are made by phase inversion processing, but do not produce hydrophilicity gradients and charge distribution gradients.

For example, the quaternary phosphonium polymers of the prior art such as those described in Wang et al (Desalination 292, 119 (2012)) are constructed by casting on a piece of commercially available polyethersulphone substrate. Other methods of manufacture such as those described in U.S. Pat. No. 6,071,406 or U.S. Pat. No. 7,560,024 do not product a gradient change or hydrophilicity distribution.

Other aspects and preferred forms are disclosed in the specification and/or defined in the appended claims, forming a part of the description of the invention.

In essence, embodiments of the present invention stem from the realization that imparting a high degree of polarisation and distinct hydrophilic and hydrophobic ends to a membrane can impart improved functionality to the membrane.

Advantages provided by the present invention comprise the following:
the membranes have improved water permeability, typically 5 to 10 times higher water permeability than commercial polyethersulphone-based membranes with similar pore size;
the membranes have improved filtration efficiency as compared with the prior art;
the membranes can be readily prepared by known preparative techniques such as phase inversion;
suitable preparative techniques for the membranes are well suited to large-scale production; and
the membranes can be economically produced.

The ultrafiltration membrane of the present invention would have a number of applications including:
water treatment, such as desalination, purification and pre-treatment prior to desalination, and
bio-separation, such as for the pharmaceutical industry, medical industry and bio-process engineering.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

The present invention may be better understood by those skilled in the relevant art by reference to the following description of embodiments and the accompanying drawings, which are illustrations only and do not limit the disclosure herein:

FIG. 1 illustrates the following:

FIG. 1a—Molecular structure of tris(2,4,6-trimethoxyphenyl)polysulphone-methylene quaternary phosphonium chloride (TPQP-Cl);

FIG. 1b—Molecular structure of polyether sulphone (PES);

FIG. 1c—Schematic illustration of the formation of nanoporous polymer membranes in the phase inversion process: the solvent diffuses out of the cast polymer solution (1) comprising PES and TPQP-Cl into the non-solvent water (5) as indicated by the arrows while the non-solvent water (5) diffuses into the polymer solution (1) as indicated by the green arrows. This rapid exchange process leads to precipitation of PES and TPQP-Cl; the TPQP-Cl content increasing from the top surface to the bottom surface of the resulting membrane;

FIG. 1d(i)—Cross-sectional scanning electron microscopy (SEM) image of a PES/TPQP-Cl composite membrane with 20% TPQP-Cl prepared from 15% PES/TPQP-Cl solution (denoted 15% PES/TPQP-Cl 8/2); FIG. 1d(ii) is a cross-sectional SEM image of PES ultrafiltration membrane;

FIG. 1e—SEM image of active surface, showing a nanoporous structure; and

FIG. 1f—SEM image of bottom surface of the membrane.

FIG. 2 illustrates the following:

FIG. 2a—is a graph of contact angle (o) against the percentage of TPQP-Cl added to the polymer, for the bottom layer (8) and the active layer (10) of a dried membrane according to the present invention;

FIG. 2b—is a graph of actual TPQP-Cl content (determined by XPS) of the active layer (12) and bottom layer (15) of dried 15% PES membrane and 15% PES-TPQP-Cl membranes with different amounts of TPQP-Cl. The PES/TPQP-Cl membranes with a mass ratio of 9:1, 8:2, and 7:3 were prepared from a 15% polymer solution and denoted 15% PES, 15% PES/TPQP-Cl 9/1, 15% PES/TPQP-Cl 8/2, and 15% PES/TPQP-Cl 7/3, respectively.

FIG. 2c—Schematic illustration of the hydrophobicity-hydrophilicity transition before and after hydration of charged groups of the PES/TPQP-Cl composite membrane, and contact angle change for the 15% PES/TPQP-Cl 8/2 membrane before hydration (16) and after hydration (18). The porous structure of the membrane is simplified as individual conical shaped channels between the active layer (20) and the bottom layer (22) of the membrane. The degree of hydrophilicity decreases from active layer to bottom layer in the dehydrated membrane; the opposite trend is seen in the hydrated membrane, which is more hydrophobic at the active layer. The inner surface of the channels is lined by the polysulphone backbone (24) in TPQP-Cl while the quaternary phosphonium group (26) of the TPQP-Cl projects to the inside of the channel. The quaternary phosphonium groups (26) of the hydrated membrane are effectively solvated (29) with water molecules.

FIG. 3 illustrates the following:

FIG. 3a—illustrates water permeability and molecular weight cut-off (MWCO) of various polyethersulphone ultrafiltration membranes of the prior art and according to the present invention. The pore size of membrane was determined by molecular weight cut-off measurements. The following data on polymer membranes from recent literature are also included: 15% PES with 10% Pluronic F127 (31) (Susanto H & Ulbricht M, J. Membr.Sci 327, 125 (2009)), 16% PES with 2% polyvinylpyrrolidone (PVP) or 2% PVP and 5% 2-hydroxyethylmethacrylate (32) (Rahimpour A & Madaeni S S, J. Membr. Sci. 360, 371 (2010), 15% polysulphone-poly(ethylene oxide) random copolymer with 5% PVP (33) (Cho et al, J. Membr. Sci 379, 296 (2011)), 18% polysulphone (PSf), and 18% PSf with different additives (34) (Hoek et al, Delasination 283, 89 (2011)), commercial PES membranes and modified membranes (35) (Peeva et al, J. Membrane Sci 390, 99 (2012); polyacrylonitrile (36) (Boerlage et al, J. Membrane Sci 1971 (2002)), cellulose acetate-aminated poly(ether imide) (37) (Arockiasamy et al, Int. J. Polym. Mater. 57, 997 (2008)), and cellulose acetate-sulfonated polyetherimide (38) (Nagendran et al, Soft. Mater. 6, 45 (2008)), and polyvinylidene fluoride (PVDF)-co-hexafluoropropylene and modified PVDF membranes (39) (Wongchitphimon et al, J. Membrane Sci 369, 329 (2011)) and PES (40). The membranes according to the present invention were 15% PES/TPQP-Cl 8/2 (42), 16% PES/TPQP-Ci 8/2 (44), 15% PES/TPQP-Cl 7/3 (46), 13% PES/TPQP-Cl 8/2 (48) and 15% PES/TPQP-Cl 9/1 (50).

FIG. 3b—Polyethylene glycol (PEG) molecular weight cut off curves of 15% PES and the following PES/TPQP-Cl membranes according to this invention: 15% PES (52), 15% PES/TPQP-Cl 9/1 (54), 15% PES/TPQP-Cl 8/2 (56), 15% PES/TPQP-Cl 7/3 (58), 16% PES/TPQP-Cl 8/2 (60), 18% PES/TPQP-Cl 8/2 (62).

FIG. 4 includes schematic representations of the cross-sections of ultrafiltration membranes as follows:

FIG. 4a—asymmetrically porous structure of a typical ultrafiltration membrane of the prior art;

FIGS. 4b to 4f—existing membrane structures including non-charged membrane (FIG. 4b), positively charged membrane surface (FIG. 4c), negatively charged membrane surface (FIG. 4d), uniformly distributed positive charge (FIG. 4e), and uniformly distributed negative charge (FIG. 4f);

FIGS. 4g to 4j—structures of ultrafiltration membranes according to the present invention having gradient charge distribution and gradient hydrophilicity/hydrophobicity.

FIG. 5 illustrates the results of contact angle testing of membranes constructed of polyethersulphone (FIG. 5a) and tris(2,4,6-trimethoxyphenyl)polysulphone-methylene quaternary phosphonium chloride (FIG. 5b).

### DETAILED DESCRIPTION

The present invention provides nanoporous polymer membranes that can provide fast water transport by creation of a hydrophilicity gradient coupled and/or a charge density gradient. The membrane may be manufactured using conventional techniques such as a phase inversion process.

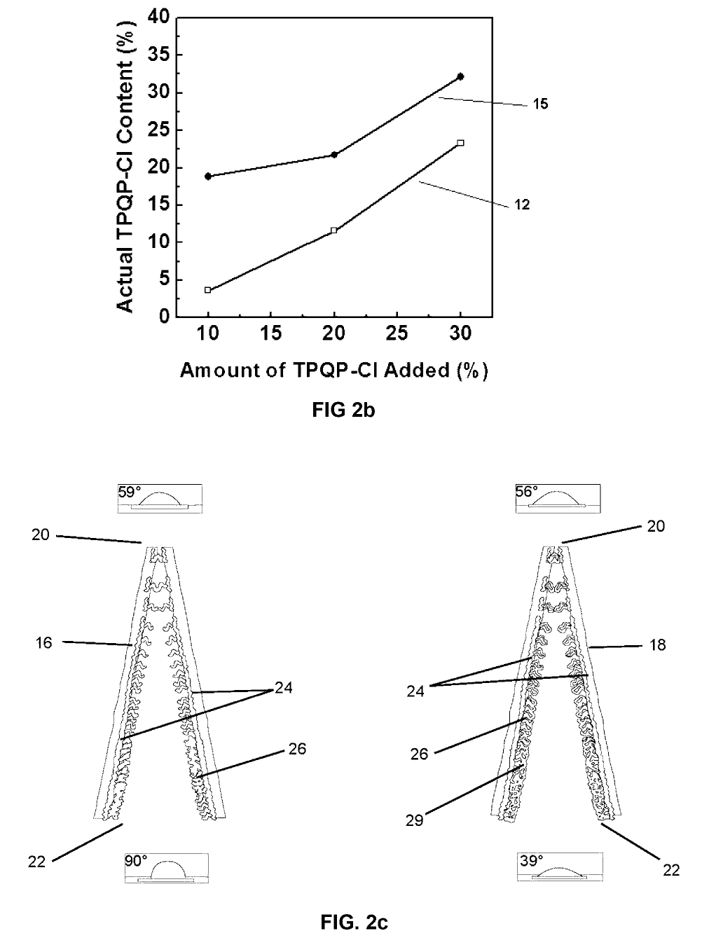

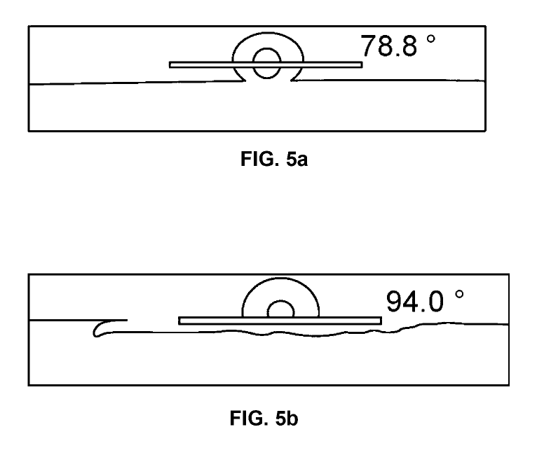

The enhancements in water transport rates associated with the membranes of the present invention over continuum flow model predictions are very close to those observed in carbon nanotubes. The membranes are produced by incorporating a hydrophobic and charged polymer in the membrane fabrication process. In particular, tris(2,4,6-trimethoxyphenyl)polysulphone-methylene quaternary phosphonium chloride (TPQP-Cl) with an intrinsic contact angle of 94° (measured from dense TPQP-Cl films) is chosen as an additive in the preparation of polyethersulphone (PES) membranes (PES has an intrinsic contact angle of 79°, measured from dense PES films) (FIG. 5a, FIG. 5b). Because TPQP-Cl is more hydrophobic than PES, it migrates to the substrate due to the difference in the de-mixing rate during the phase inversion process, leading to an increase in TPQP-Cl content from the top active layer to the bottom supporting layer (FIG. 2c).

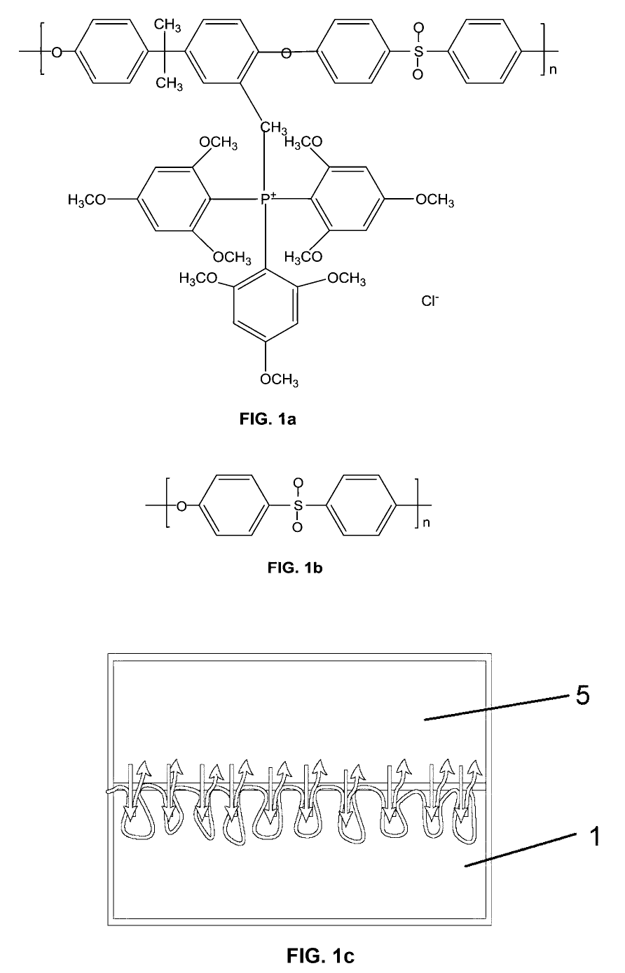

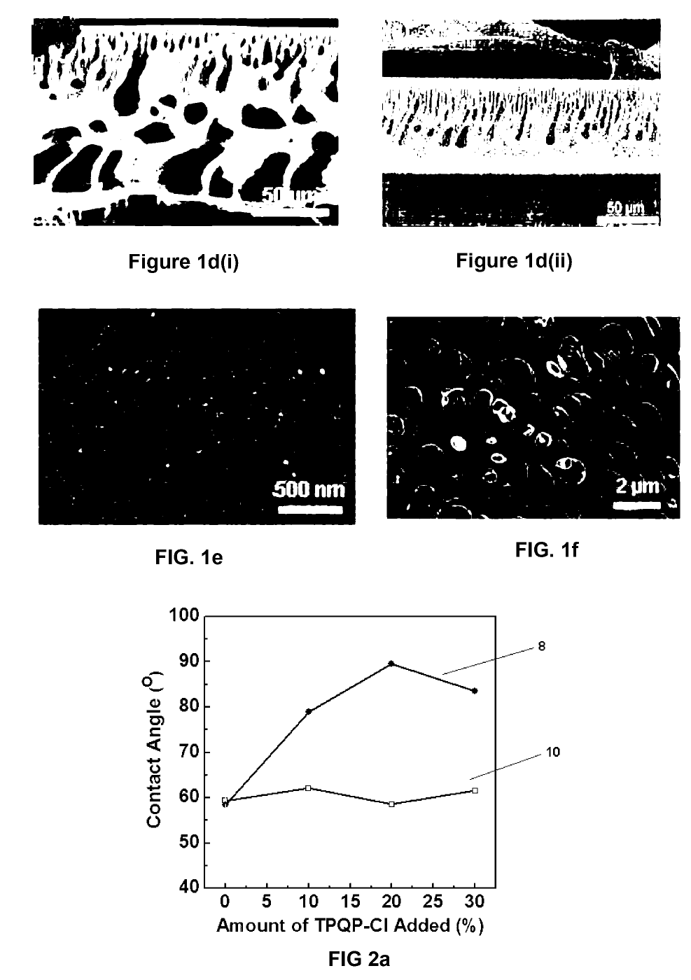

Scanning electron microscopy (SEM) images show that the PES/TPQP-Cl membrane exhibits a typical asymmetrical microstructure with a thin active skin layer and a finger-like macroporous supporting layer (FIG. 1d(i) & (ii), FIG. 1e).

The water contact angle of dried PES and PES/TPQP-Cl membranes is illustrated graphically in FIG. 2a. The PES and PES/TPQP-Cl membranes with different PES/TPQP-Cl mass ratios (9:1, 8:2, and 7/3) prepared from 15% polymer solutions were denoted 15% PES, 15% PES/TPQP-Cl 9/1, 15% PES/TPQP-Cl 8/2, and 15% PES/TPQP-Cl 7/3, respectively.

The contact angle of the active layer remains almost the same at different TPQP-Cl loadings whereas the contact angle of the bottom surface increases significantly from 60° to 90° when the TPQP-Cl/PES ratio increases to 2:8, and then slightly decreases to 84° at a 30 wt % TPQP-Cl loading. The small decrease in contact angle of the bottom surface from 15% PES/TPQP-Cl 8/2 to 15% PES/TPQP-Cl 7/3 can be explained by the fact that the former has a somewhat rougher bottom surface than the latter.

The TPQP-Cl concentration gradient across the dry membrane cross section is confirmed by X-ray photoelectron spectroscopy (XPS) (FIG. 2b). Note that the elemental composition obtained from XPS is the average value within a few microns thickness from the surface due to the effect of X-ray penetration. Interestingly, as compared with conventional membranes, a reverse hydrophilicity gradient (the bottom supporting layer is more hydrophilic than the active layer) is ultimately produced due to hydration of charged groups of TPQP-Cl.

The contact angle data shown in FIG. 2c demonstrate that the hydrophobicity-hydrophilicity transition occurs in PES/TPQP-Cl composite membranes with a gradient distribution of TPQP-Cl inverting between the dry state and wet state. The wetability of the active layer does not change much before and after hydration. However, in wet PES/TPQP-Cl membranes, the bottom surface becomes much more hydrophilic, clearly indicating a hydrophilicity gradient (coupled with a charge density gradient) from the active layer to the bottom supporting layer. By contrast, the contact angle of active layer of wet 15% PES control membrane is 58.5°, which is close to that of its bottom surface (59.3°), confirming that there is no wetability gradient present in the membrane.

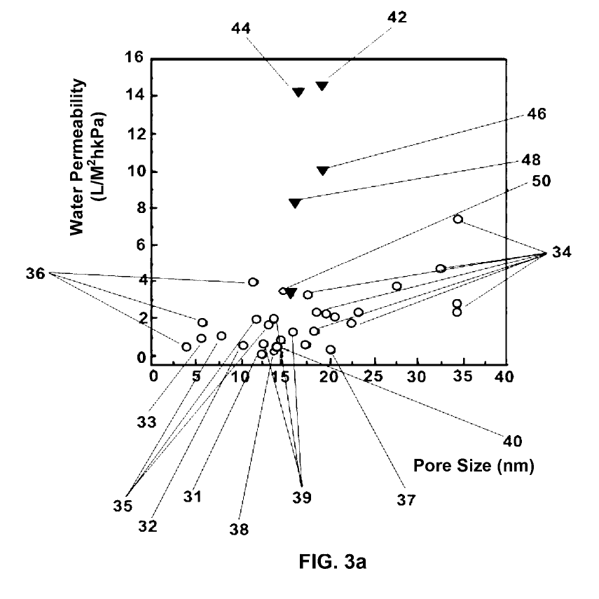

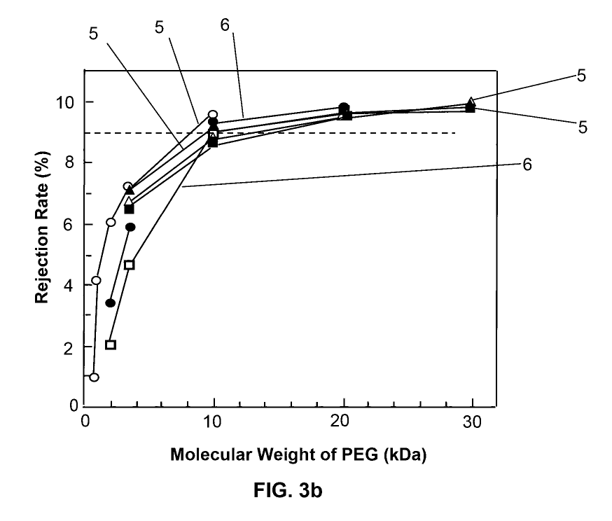

The water permeability, and pore size of the PES and PES/TPQP-Cl membranes studied in this work are presented in FIG. 3a. The polyethylene glycol (PEG) molecular weight cut off (MWCO) curves of these membranes are shown in FIG. 3b, and the MWCO at 90% rejection rate was used to calculate the pore size of the membrane. Without any additive, 15% PES control membranes have a water permeability of 0.46 L/m² h kPa. All membranes with TPQP-Cl (15% PES/TPQP-Cl) show remarkably higher water permeability than 15% PES membrane; and 15% PES/TPQP-Cl 8/2 membrane exhibits the highest water permeability (14.6 L/m² h kPa), which is 32 times higher than that of 15% PES membrane. PES/TPQP-Cl membranes prepared from different concentrations of polymer casting solutions show different permeation properties.

Comparison of the water permeability and the pore size of skin layer for the membranes prepared from casting solutions with 16% and 18% and a fixed PES/TPQP-Cl mass ratio of 8:2 (denoted 16% PES/TQPQ-Cl 8/2 and 18% PES/TPQP-Cl) are shown in FIG. 3a. With increasing polymer concentration, the pore size of skin layer slightly decreases (Table 1) while the pore size and porosity of the bottom layer (surface) decreases more significantly based on SEM observations. The water permeability drops only 2% when the polymer concentration increases from 15% to 16%, but it decreases by 41% when the polymer concentration rises from 16% to 18%. It is noted that a dense skin layer was formed from 18 wt % PES casting solution, and this PES membrane was impermeable to water at a testing pressure of 450 kPa.

As shown in FIG. 3b, the PES/TPQP-Cl membranes have narrow MWCOs, and maintain excellent separation properties at high water permeabilities. For comparison, the water permeability versus pore size of typical polymer ultrafiltration membranes recently reported in the literature is included in FIG. 3a. It is clear that the water permeabilities of PES/TPQP-Cl membranes greatly exceed other membranes with similar pore sizes.

The measured water fluxes are 35 to 57 times higher than those of the no-slip hydrodynamic flows from the Hagen-Poiseuille model. The enhancement can be explained in terms of slip length, which is an extrapolation of the extra pore radius required to give zero velocity at a hypothetical pore wall (the boundary condition for Hagen-Poiseuille flow). The estimated minimum slip lengths are summarized in Table 1 which records comparisons of experimental water fluxes with continuum flow model predictions. Values for carbon nanotubes and polycarbonate membranes from Han et al (J. Membrane Sci, 2010 358(1-2) p. 142-149) are included as a reference. Pore diameters were calculated from PEG molecular weight cut-off values at 90% rejection rate (FIG. 3b). Pore density values were determined by counting the number of pores on 2.5 μm×2.0 μm high resolution SEM images of the active surfaces of membranes.

TABLE 1

| | | | | En- | |
|---|---|---|---|---|---|
| | | | | hancement | Mini- |
| | | Pore | Thick- | over non- | mum |
| | Pore | number | ness of | slip, hydro- | slip |
| | size | density | active | dynamic | length |
| Sample | (nm) | (cm⁻²) | layer | flow | (nm) |
| 15% PES | 14.3 | 3.6 × 10⁹ | 500 nm | 2.4 | 3.0 |
| 15% PES/ | 15.7 | ~1.0 × 10¹⁰ | | 36 | 69 |
| TPQP- | | | | | |
| CI 9/1 | | | | | |
| 15% PES/ | 19.2 | | | 42 | 99 |
| TPQP- | | | | | |
| CI 8/2 | | | | | |
| 15% PES/ | 19.2 | | | 27 | 62 |
| TPQP- | | | | | |
| CI 7/3 | | | | | |
| 16% PES/ | 16.5 | | | 57 | 117 |
| TPQP- | | | | | |
| CI 8/2 | | | | | |
| 18% PES/ | 16.1 | | | 35 | 67 |
| TPQP- | | | | | |
| CI 8/2 | | | | | |
| Double-walled | 1.3 to | ≦0.25 × 10¹² | 2 μm | 560 to | 140 to |
| carbon | 2.0 | | | 8400 | 1400 |
| nanotubes | | | | | |
| Polycarbonate | 15 | 6 × 10⁸ | 6 μm | 2.1 | 5.1 |

As TPQP-Cl content varies from 10 to 30%, the slip length varies from 62 to 117 nm. In contrast, the PES control membrane has a slip length of 3.0 nm, which is comparable with the polycarbonate membrane with a pore size of 15 nm. Surprisingly, the slip lengths of our PES/TPQP-Cl membranes are very close to those of double-walled carbon nanotube membranes (Table 1), which are well recognized nanochannels with enhanced water permeability. Molecular dynamic modelling revealed that increasing nanotube diameter leads to a reduction in slip length, and the slip length for a carbon nanotube with a pore diameter of around 20nm is 54-67 nm, which is comparable with polymer membranes of the present invention.

The extensive molecular dynamic (MD) studies on CNT membranes have identified that the atomically smooth solid walls and the hydrophobic nature of CNTs are the key factors for the large slip length. But it is highly unlikely that our hydrophilic polymer nanopores would have a similar smoothness to CNTs, although the tortuous pores may exhibit a certain degree of smoothness locally arising from the arrangement of hydrated aromatic quaternary phosphonium groups on TPQP-Cl. Therefore, it seems that the pore surface smoothness is not responsible for the high water permeability in our experiments.

Positron annihilation lifetime spectroscopy (PALS) results show the addition of TPQP-Cl does not affect the Å-sized free volumes of these polyethersulphone membranes. High water flux should only occur in the nanoporous channels (14-20 nm in diameter) of the membranes. In addition, the small increase in the pore size and pore density of the active layer and the moderate increase in the porosity of supporting layer may also contribute to enhanced water flux.

A hydrodynamic model of a flow in a cone to describe the water transport in membranes of the present invention. The changes in pore size, pore number density, and thickness of the membranes only resulted in up to 5.8 times enhancement in water flux through the PES/TPQP-Cl membrane, which is far smaller than the observed 32 times enhancement. Therefore the change of membrane microstructure only plays a minor role in promoting water permeation through our PES/TPQP-Cl membranes.

The fast water transport through the PES/TPQP-Cl membranes can be mainly attributed to the unique combination of pore surface wettability gradient and charge density gradient. To examine the effect of surface charge, an electrolyte solution was used to electrostatically shield the pore surface charge in the filtration process. The flux of 1 M NaCl aqueous solution through 15% PES/TPQP-Cl 8/2 membrane was found to be around 50% lower than the pure water flux; whereas the flux of 1 M NaCl aqueous solution through 15% PES control membrane was similar to the pure water flux.

This observation strongly suggests that the shielding effect caused by the accumulated Na⁺ and Cl⁻ ions on the charged pore surfaces leads to a large increase in the water flow resistance. Therefore, this experimental result demonstrates that the surface charge gradient plays a crucial role in the remarkably high water permeability observed for the PES/TPQP-Cl membranes. In addition, the hydrophilicity gradient in the membranes of the present invention should also contribute to the enhanced water flow by promoting directional water movement.

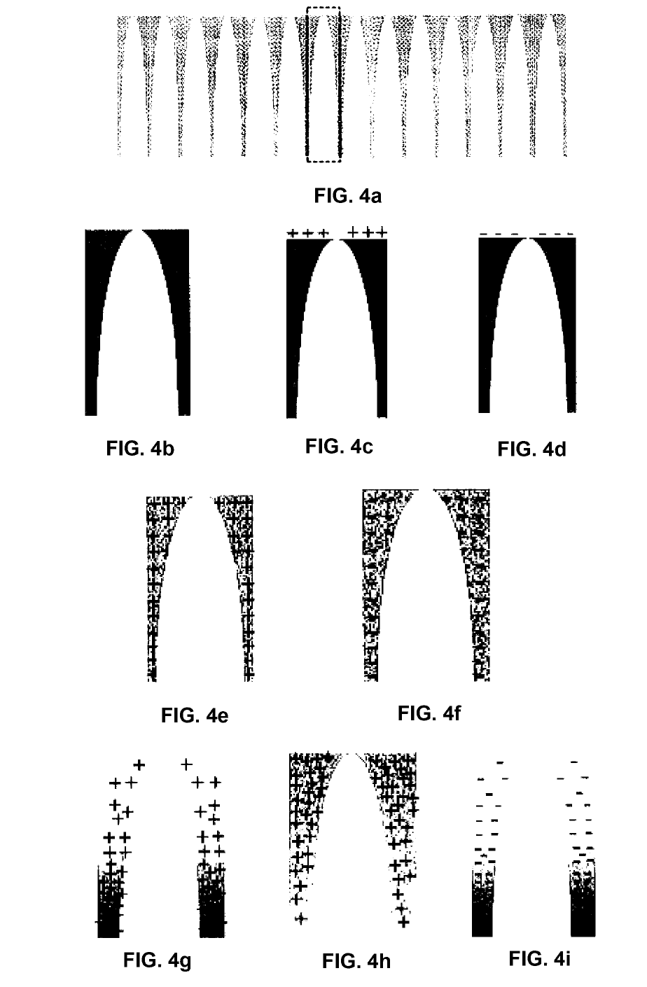

The membrane of the present invention and its characterising properties can also be described with reference to FIG. 4. FIG. 4 shows asymmetrically porous structures of a typical ultrafiltration membrane, existing membranes with non-charged porous structure and uniform charge distribution, as compared with membranes according to the present invention which have gradient charge distribution and gradient hydrophilicity and hydrophobicity.

In membranes of the prior art either positive charge or negative charge is uniformly distributed on the membrane surface or throughout the membrane (FIGS. 4b to 4f).

By contrast, the membrane structure of membranes according to the present invention (FIGS. 4g to 4j), both the charge and hydrophilicity/hydrophobicity exhibit gradient distribution from the skin layer towards the bottom layer. Without wishing to be bound by theory it is believed that because of these unique structures, the ultrafiltration membranes of the present invention show extraordinarily high water flux.

### PREPARATIVE EXAMPLE

Ultrafiltration membranes according to the present invention were prepared by phase inversion. Quaternary-phosphonium polymer (FIG. 1a) (at least 40 wt % of total polymers) and polyethersulphone (FIG. 2b) (up to 60 wt % of total polymers) was dissolved in DMF with stirring. The resulting polymer solutions without air bubbles were cast using a micrometer film applicator onto a clean glass plate to a thickness of 100 to 500 micron.

The membrane was produced in a coagulation bath filled with double deionised water or other solvents, followed by washing in double deionised water. The resulting membranes were soaked in deionised water for future use.

Contact angle measurements using a drop of 5 μL water revealed that positively charged TPQP-Cl is more hydrophobic than PES. (FIG. 5)

The concentration of polymer solution and ratio of PES/TPQPCl can be varied to fabricate the ultrafiltration membranes with different filtration properties. For example, use of a 15 wt % polymer solution with a PES/TPQP-Cl mass ratio of 80/20 is used, the resulting ultrafiltration membrane has a water flux of 1252 Lm⁻² h⁻¹ (LMH) at a testing pressure of 100 kPa, which is about 45 times the water flux of pure PES membrane (25 LMH at 100 kPa). The molecular weight cut off (MWCO) of pure PES membrane is about 75000 (pore size of about 14.4 nm), whereas the PES-TPQP-Cl membrane exhibits the highest water flux, and a MWCO of 135000 (pore size of about 19.2 nm).

FIGS. 1d(i) and 1d(ii) compares the microstructure of the PES-TPQP-CL membrane with PES. Both membranes show asymmetric structures consisting of a top thin selective skin layer, a thick bottom layer with fully developed macro-voids. With an addition of TPQP-CL, macrovoids at the bottom increased in number and size.

Table 2 lists the contact angle of PES and PES-TPQP-Cl ultrafiltration membranes. As listed in Table 2, the hydrophobicity of the top skin layer is similar to that of the bottom layer in the PES ultrafiltration membrane.

TABLE 2

| | Top surface | Bottom surface |
|---|---|---|
| | contact angle | contact angle |
| Ultrafiltration Membrane | (°) | (°) |
| PES membrane | 59.4 ± 3.3 | 61.3 ± 4.3 |
| PES membrane with 20% | 58.6 ± 2.8 | 89.6 ± 3.1 |
| TPQP-CI | | |

However in PES-TPQP-Cl membrane the skin layer is more hydrophilic than the bottom layer. In addition XPS elemental analysis of PES-TPQP-Cl membrane shows that the skin layer contains 0.33 mol % P, and the bottom layer has 0.48 mol % P (ie 45.5% increase) indicating that the charge density gradually increases from the skin layer to the bottom layer.

It is because the fabrication of PES-TPQP-Cl membrane, PES-TPQP-Cl is more hydrophobic than PES, and it will be pushed from the skin layer to the bottom layer during solvent exchange with water from the top surface in the phase inversion process. Without wishing to be bound by theory it is believed that this unique gradient structure causes a dramatic enhancement in water flux due to large differences in surface charge and surface tension between the skin layer and the bottom layer.

After the PES-TPQP-Cl membrane was ion-exchanged with 1M KOH solution, the resulting PES-TPQP-OH⁻ ultrafiltration membrane had a water flux of 1095 LMH with a testing pressure of 100 kPa, which was slightly lower than that of PES-TPQP-Cl membrane. While the PES-TPQP-Cl membrane was treated in 1M NaF solution to ion-exchange Cl⁻ with F⁻, the resulting PES-TPQP-F membrane exhibited a water flux of 1303 LMH at a testing pressure of 100 kPa, which was slightly higher than that of PES-TPQP-Cl.

The water permeability and MWCO of these membranes are plotted in FIG. 6 in comparison with ultrafiltration membranes of the prior art. In this figure the water permeability and MWCO of all the membranes were determined using the same testing method. There is a trade-off between the water permeability and the pore size of the top skin layer of the membranes. As clearly shown in FIG. 3a, PES-TPQP-Cl, PES-TPQP-OH and PES-TPQP-F membranes show extraordinarily high water permeability as compared with all other membranes. Therefore our new membranes have great potential to largely improve filtration efficiency and reduce the costs of ultrafiltration processes in a wide range of applications including clean water production, wastewater treatment, food processing and bioprocessing.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. An ultrafiltration membrane comprising:
(i) a first polymer, and
(ii) a second, charged polymer
wherein the first polymer and second polymer have different hydrophobicities.

2. The ultrafiltration membrane according to claim 1 having a charge density gradient.

3. The ultrafiltration membrane according to claim 1 having a hydrophilicity gradient.

4. The ultrafiltration membrane according to claim 1 wherein the first polymer is chosen from the group comprising polysulphone, polyethersulphone, polyacrylonitrile, cellulose acetate or poly(vinylidene fluoride).

5. The ultrafiltration membrane according to claim 1 wherein the second polymer is chosen from quaternary phosphonium polymers.

6. The ultrafiltration membrane according to claim 1 wherein the second polymer is chosen from the group comprising diphenyl(3-methyl-4-methoxyphenyl) tertiary sulphonium functionalized polysulphone, tris(2,4,6-trimethoxyphenyl) quaternary phosphonium-substituted bromomethylated poly(phenylene oxide), sulphonated poly(2,6-dimethyl-1,4-phenylene oxide) and tris(2,4,6-trimethoxyphenyl)polysulphone-methylene quaternary phosphonium chloride.

7. The ultrafiltration membrane according to claim 1 having a water permeability between 0.46 and 20.00 L/m² h kPa, more preferably between 10.00 and 16.00 L/m² h kPa

8. The ultrafiltration membrane according to claim 1 having water flux of between 25 and 2000 Lm⁻² h⁻¹ at a testing pressure of 100 kPa, preferably between 1,000 and 1,500 Lm⁻² h⁻¹ at a testing pressure of 100 kPa.

9. An ultrafiltration membrane according to claim 1.

10. A method of preparing the ultrafiltration membrane of claim 1 including the step of combining the first polymer with the second charged polymer.

11. The method according to claim 10 including the step of phase inversion.

12. The method according to claim 10 wherein the first polymer is combined with the second polymer and a solvent to form a solution, wherein the total polymer concentration in the solution is between 12 and 20 wt %.

13. The method according to claim 10 wherein the first polymer is combined with the second polymer and a solvent to form a solution, wherein the amount of second polymer is up to 60 wt % of the total amount of polymer in solution.

14. The method according to claim 10 wherein the solvent is chosen from N-methyl-2-pyrrolidone, dimethylformamide, or mixtures thereof.
